(19) United States
(12) Patent Application Publication
(10) Pub. No.: US 2025/0006215 A1
(43) Pub. Date: Jan. 2, 2025

(54) VOICE SEPARATION METHOD AND APPARATUS, ELECTRONIC DEVICE AND READABLE STORAGE MEDIUM

(71) Applicant: Beijing Zitiao Network Technology Co., Ltd., Beijing (CN)

(72) Inventor: Xin WANG, Beijing (CN)

(21) Appl. No.: 18/712,467

(22) PCT Filed: Nov. 2, 2022
(86) PCT No.: PCT/CN2022/129118

§ 371 Date: May 22, 2024

(30) Foreign Application Priority Data
Nov. 22, 2021 (CN) 202111386550.8

(51) Int. Cl. G10L 21/0308; G10L 17/02; G10L 17/04; G10L 17/06; G10L 25/30

(52) U.S. Cl. CPC G10L 21/0308; G10L 17/02; G10L 17/04; G10L 17/06; G10L 25/30

(57) ABSTRACT

A voice separation method and apparatus, an electronic device, and a readable storage medium. The method comprises: obtaining a voice feature corresponding to a voice to be processed and a bottleneck feature corresponding to a reference voice (S101); inputting, into a voice separation model, the voice feature corresponding to the voice to be processed and the bottleneck feature corresponding to the reference voice and obtaining a voice detection result output by the voice separation model (S102); and determining, on the basis of the voice detection result, a target voice segment matching the reference voice in the voice to be processed, wherein the voice feature of the target voice segment matches the bottleneck feature of the reference voice (S103). According to the method, the voice feature corresponding to the voice to be processed and the bottleneck feature corresponding to the reference voice are used as the joint input of a voice separation system, and a target voice is separated from the voice to be processed.

### CROSS-REFERENCE TO RELATED APPLICATIONS

The present application is based on and claims priority to CN patent application No. 202111386550.8 filed on Nov. 22, 2021, the disclosure of which is incorporated by reference herein in its entirety.

### TECHNICAL FIELD

The present disclosure relates to the field of voice processing technology, in particular to a voice separation method and apparatus, an electronic device and a readable storage medium.

### BACKGROUND

The Voice Activity Detection (VAD) technology is widely applied in a front-end of voice recognition to detect a voice and a non-voice. In some scenarios, it is necessary not only to detect a voice and a non-voice, but also to separate a target voice.

In the related art, voice separation is realized by “VAD system+voice recognition and separation system”; specifically, first of all, end-point detection is performed by a VAD system on voice, and a target voice is separated by a voice recognition and separation system on the basis of an end-point detection result.

### SUMMARY

The present disclosure provides a voice separation method and apparatus, an electronic device and a readable storage medium.

In a first aspect of the present disclosure, a voice separation method is provided, the method comprising:
obtaining a voice feature corresponding to a voice to be processed and a bottleneck feature corresponding to a reference voice;
inputting, into a voice separation model, the voice feature corresponding to the voice to be processed and the bottleneck feature corresponding to the reference voice and obtaining a voice detection result output by the voice separation model; and
determining, on the basis of the voice detection result, a target voice segment matching the reference voice in the voice to be processed, wherein the voice feature corresponding to the target voice segment matches the bottleneck feature corresponding to the reference voice.

As one possible implementation, the inputting, into a voice separation model, the voice feature corresponding to the voice to be processed and the bottleneck feature corresponding to the reference voice and obtaining a voice detection result output by the voice separation model comprises:
inputting the voice feature corresponding to the voice to be processed into a first neural network comprised in the voice separation model, and obtaining a vector expression corresponding to the voice feature output by the first neural network;
splicing the vector expression corresponding to the voice feature and the bottleneck feature corresponding to the reference voice to obtain a fusion feature; and
inputting the fusion feature into a second neural network comprised in the voice separation model, obtaining a matrix output by the second neural network, and obtaining a voice detection result on the basis of the matrix.

As one possible implementation, the obtaining a voice detection result on the basis of the matrix comprises:
obtaining the probability values that each audio frame pertains to a first category and a second category respectively according to an element corresponding to the each audio frame comprised in the matrix; the voice feature corresponding to the audio frame comprised in the first category matches the bottleneck feature corresponding to the reference voice, and the voice feature corresponding to the audio frame comprised in the second category does not match the bottleneck feature corresponding to the reference voice; and
determining a voice detection result corresponding to the each audio frame on the basis of a maximum value of the probability values that the each audio frame pertains to a first category and a second category respectively, the voice detection result corresponding to the audio frame is used for indicating whether the voice feature corresponding to the audio frame matches the bottleneck feature corresponding to the reference voice.

As one possible implementation, the voice separation model is obtained by training on the basis of the voice feature corresponding to the sample voice, the bottleneck feature corresponding to the sample voice and a labeled voice detection result of the sample voice, and the sample voice comprises the reference voice.

As one possible implementation, the voice feature comprises one or more of a FBank feature, a Mel frequency spectrum feature or a pitch feature.

In a second aspect of the present disclosure, a voice separation device is provided, the device comprising:
an obtaining module configured to obtain a voice feature corresponding to a voice to be processed and a bottleneck feature corresponding to a reference voice;
a voice detection module configured to input the voice feature corresponding to the voice to be processed and the bottleneck feature corresponding to the reference voice into a voice separation model and obtaining a voice detection result output by the voice separation model; and
a separation module configured to determine a target voice segment matching the reference voice in the voice to be processed on the basis of the voice detection result, wherein the voice feature of the target voice segment matches the bottleneck feature of the reference voice.

As one possible implementation, the voice detection module is specially configured to input the voice feature corresponding to the voice to be processed into a first neural network comprised in the voice separation model and obtain a vector expression corresponding to the voice feature output by the first neural network; splice the vector expression corresponding to the voice feature and the bottleneck feature corresponding to the reference voice to obtain a fusion feature; and input the fusion feature into a second neural network comprised in the voice separation model, obtain a matrix output by the second neural network, and obtain the voice detection result on the basis of the matrix.

As one possible implementation, the voice detection module is specifically configured to obtain the probability values that the each audio frame pertains to a first category and a second category respectively according to an element corresponding to the each audio frame comprised in the matrix, wherein the voice feature corresponding to the audio frame comprised in the first category matches the bottleneck feature corresponding to the reference voice, and the voice feature corresponding to the audio frame comprised in the second category does not match the bottleneck feature corresponding to the reference voice; and determine a voice detection result corresponding to the each audio frame based on a maximum value of the probability values that the each audio frame pertains to a first category and a second category respectively;
wherein, the voice detection result corresponding to the audio frame is used to indicate whether the voice feature corresponding to the audio frame matches the bottleneck feature corresponding to the reference voice.

As one possible implementation, the voice separation model is obtained by training on the basis of the voice feature corresponding to the sample voice, the bottleneck feature corresponding to the sample voice and the labeled voice detection result of the sample voice, and the sample voice comprises the reference voice.

As one possible implementation, the voice feature comprises one or more of a FBank feature, a Mel frequency spectrum feature, a bottleneck feature or a pitch feature.

In a third aspect of the present disclosure, an electronic device is provided, the device comprising: a memory and a processor;
the memory is configured to store computer program instructions; and
the processor is configured to execute the computer program instructions, so that the electronic device realizes the voice separation method according to any of the first aspect.

In a fourth aspect of the present disclosure, a readable storage medium is provided, the medium comprising: computer program instructions;
at least one processor of an electronic device executes the computer program instructions to realize the voice separation method according to any of the first aspect.

In a fifth aspect of the present disclosure, a computer program product is provided, and the product, when executed by a computer, causes the computer to realize the voice separation method according to any of the first aspect.

The embodiment of the disclosure provides a voice separation method and apparatus, an electronic device and a readable storage medium, wherein the method comprises: obtaining a voice feature corresponding to a voice to be processed and a bottleneck feature corresponding to a reference voice; inputting, into a voice separation model, the voice feature corresponding to the voice to be processed and the bottleneck feature corresponding to the reference voice and obtaining a voice detection result output by the voice separation model; determining, on the basis of the voice detection result, a target voice segment matching the reference voice in the voice to be processed, wherein the voice feature of the target voice segment matches the bottleneck feature of the reference voice. In the embodiment of the present disclosure, the system for realizing voice separation is implemented in an end-to-end manner, and the voice feature corresponding to the voice to be processed and the bottleneck feature corresponding to the reference voice are used as the joint input of a voice separation system for separating the target voice from the voice to be processed.

### BRIEF DESCRIPTION OF THE ACCOMPANYING DRAWINGS

The accompanying drawings here, which are incorporated into the specification and constitute part of this specification, illustrate the embodiments conforming to the present disclosure and serve to explain the principles of the present disclosure together with the specification.

In order to explain the technical solution in the embodiments of the present disclosure or in the related art more explicitly, the accompanying drawings required to be used in the description of the embodiments or the related art will be briefly introduced below; obviously, for those of ordinary skill in the art, other accompanying drawings may also be obtained according to these accompanying drawings on the premise that no inventive effort is involved.

FIG. 1 is a flow chart of a voice separation method provided by one embodiment of the present disclosure;

FIG. 2 is a schematic structural view of a voice separation model provided by one embodiment of the present disclosure;

FIG. 3 is a flow chart of a voice separation method provided by another embodiment of the present disclosure;

FIG. 4 is a schematic structural view of a voice separation device provided by one embodiment of the present disclosure;

FIG. 5 is a schematic structural view of an electronic device provided by one embodiment of the present disclosure.

### DETAILED DESCRIPTION

In order to understand the above-described objects, features and advantages of the present disclosure more explicitly, the solution of the present disclosure will be further described below. It is to be noted that, the embodiments of the present disclosure and the features in the embodiments may be combined with each other in the case where contradiction is absent.

In the following description, many specific details will be elaborated in order to adequately understand the present disclosure, however, the present disclosure may be implemented in other methods than that described here; apparently, the embodiments in the specification are only some of the embodiments of the present disclosure, rather than all of the embodiments.

The performance of the VAD system and the performance of the voice recognition and separation system have great influence on the accuracy of a voice separation result, therefore, when the above-described voice separation system is used, separation training is required for the VAD system and the voice recognition and separation system, so that it is very complicated.

As an example, the voice separation method provided by the present disclosure may be realized by the voice separation device provided by the present disclosure. The voice separation device may be implemented by any software and/or hardware. As an example, the voice separation device may be: a tablet computer, a cell phone (for example, a folding screen cell phone, a large screen cell phone, and the like), a wearable device, a vehicle-mounted device, an augmented reality (AR)/virtual reality (VR) device, a notebook computer, an ultra-mobile personal computer (UMPC), a netbook, a personal digital assistant (PDA), a smart television, a smart screen, a high-definition television, a 4K television, a smart speaker, a smart projector and other of the internet of things (IoT) devices; the present disclosure is not limited to a specific type of the electronic device.

The voice separation method provided by the present disclosure will be introduced in detail below with an electronic device performing the voice separation method as an example in conjunction with several specific embodiments.

FIG. 1 is a flow chart of a voice separation method provided by one embodiment of the present disclosure. Referring to FIG. 1, the method provided by this embodiment comprises:

In S101, a voice feature corresponding to a voice to be processed and a bottleneck feature corresponding to a reference voice are obtained.

The present disclosure is not limited to parameters such as the duration, storage format and content of the voice to be processed. The electronic device may obtain the voice feature corresponding to the voice to be processed, wherein the voice feature may comprise one or more of a FBank feature (filter bank feature), a Mel frequency spectrum feature, a bottleneck feature or a pitch feature.

Since the filters for obtaining the FBank features overlap with each other, the features of each dimension in the FBank features are highly correlated; with the FBank features as the voice features of the voice to be processed, the voice separation system may use the correlation between the features of each dimension in the FBank features to output an accurate voice detection result.

For the Mel frequency spectrum feature, feature extraction is performed in mel domain which is closer to the human auditory system, so that a sound may be presented more accurately.

For the pitch feature, pitch is a perceptual attribute that allows for sorting a sound on a frequency-related scale. Pitch may be quantized into frequency, which is referred to as fundamental frequency (F0). Pitch change forms a tone of a tonal language, which is an important feature of speaker recognition and voice recognition.

In addition, the present disclosure is not limited to an implementation of obtaining the voice feature corresponding to the voice to be processed by the electronic device; for example, the electronic device may perform feature extraction on the voice to be processed by using a voice feature extraction model such as an ASR model, or the electronic device may also convert the signals of the voice to be processed by using the digital processing technology, so as to obtain the voice feature corresponding to the voice to be processed.

Bottleneck is a nonlinear feature transformation technology and an effective dimension reduction technology. The bottleneck feature may comprise information of dimensions such as rhythm and content. In the present disclosure, the bottleneck feature corresponding to the reference voice is mainly used to implement distinguishing which audio frames in the voice to be processed are the target audio frames to be separated, wherein the electronic device may perform feature extraction on the reference voice on the basis of a separate neural network so as to obtain the bottleneck feature corresponding to the reference voice.

In S102, the voice feature corresponding to the voice to be processed and the bottleneck feature corresponding to the reference voice are input into a voice separation model and a voice detection result output by the voice separation model is obtained.

Wherein, a voice detection result.

Wherein, if the audio frame comprised in the voice to be processed matches the reference voice, it means that the audio frame is a target audio frame required to be separated. If the audio frame comprised in the voice to be processed does not match the reference voice, it means that the audio frame is not a target audio frame required to be separated.

In one possible implementation, the electronic device may perform voice detection on the voice to be processed by a pre-trained voice separation model and output a voice detection result. Specifically, the voice feature corresponding to the voice to be processed and the bottleneck feature corresponding to the reference voice may be used as the input of a voice separation model which may output a classification label of whether each audio frame of the voice to be processed matches the reference voice, wherein the classification label is a voice detection result.

In another possible implementation, for the voice to be processed, the bottleneck feature of each audio frame comprised in the voice to be processed is extracted by using a processing process and method similar to the bottleneck feature, and a classification result corresponding to the audio frame is determined by calculating the similarity between the bottleneck feature and the bottleneck feature of each audio frame. Wherein, the method of calculating the similarity may comprise, but is not limited to consine distance, inner product, and the like; then, a preset distance threshold is preset so that the distance value corresponding to each audio frame is compared with the preset distance threshold to obtain a classification result corresponding to the audio frame.

That is, in this implementation, the voice feature corresponding to the voice to be processed is the bottleneck feature corresponding to the voice to be processed.

In S103, a target voice segment matching the reference voice in the voice to be processed is determined on the basis of the voice detection result, wherein the voice feature corresponding to the target voice segment matches the bottleneck feature corresponding to the reference voice.

The electronic device may determine a target voice segment matching the reference voice from the voice to be processed on the basis of the voice detection result corresponding to each audio frame. Wherein, the voice feature corresponding to the target voice segment matches the bottleneck feature corresponding to the reference voice, which means that the pitch matching degree of the pitch of the target voice segment and the pitch of the reference voice meets the requirements.

In the method provided by this embodiment, a voice feature corresponding to a voice to be processed and a bottleneck feature corresponding to a reference voice are obtained; the voice feature corresponding to the voice to be processed and the bottleneck feature corresponding to the reference voice are input into a voice separation model and a voice detection result output by the voice separation model is obtained; a target voice segment matching the reference voice in the voice to be processed is determined on the basis of the voice detection result. In the embodiment of the present disclosure, the system for realizing voice separation is implemented in an end-to-end manner, and the voice feature corresponding to the voice to be processed and the bottleneck feature corresponding to the reference voice are used as the joint input of a voice separation system for separating the target voice from the voice to be processed, so that the accuracy of the separated target voice may also be improved.

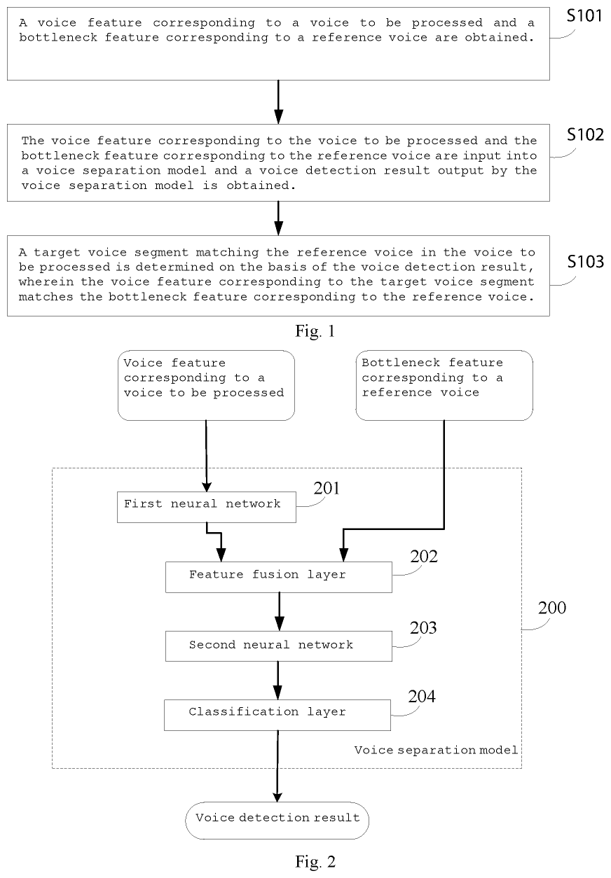

FIG. 2 is a schematic structural view of a voice separation model provided by one embodiment of the present disclosure. Referring to FIG. 2, the voice separation model 200 provided by this embodiment comprises: a first neural network 201, a feature fusion layer 202, a second neural network 203 and a classification layer 204.

Wherein, the output end of the first neural network 201 is connected with the input end of the feature fusion layer 202, the output end of the feature fusion layer 202 is connected with the input end of the second neural network 203, and the output end of the second neural network 203 is connected with the classification layer 204.

The present disclosure is not limited to parameters such as a network structure and a type of the first neural network 201 and the second neural network 203. For example, the first neural network 201 and the second neural network 203 may be a FeedForward Neural Network, a Convolution Neural Network (CNN), a Deep Feed Forward Sequential Memory Network (DFSMN), a transformer, a conformer and the like.

In practical application, the network structure with an optimal performance may be selected as the first neural network 201 and the second neural network 203 through experiments. In addition, it is also to be noted that, the types of the first neural network 201 and the second neural network 203 may be the same or different, and the present disclosure is not limited thereto.

The first neural network 201 is mainly configured to receive the voice feature of the voice to be processed as the input, and perform processing such as dimension reduction on the voice feature so as to obtain a vector expression corresponding to the voice feature. Wherein, the voice feature is represented as F1, F1∈R^{N×k1} dimension; the bottleneck feature corresponding to the reference voice is represented as F2, F2∈R^{1×k2} dimension, where N represents a total number of audio frames of the voice to be processed.

Since it is necessary to take the voice feature corresponding to the voice to be processed and the bottleneck feature corresponding to the reference voice as the joint input in the method provided by the present disclosure, if the voice feature corresponding to the voice to be processed and the bottleneck feature corresponding to the reference voice are directly spliced, since the two features have different dimensions, it is impossible to perform splicing or carry out a subsequent voice detection process, so that a processing such as dimension reduction is required for the voice feature corresponding to the voice to be processed.

Then, the output of the first neural network 201 and the bottleneck feature corresponding to the reference voice are input to the feature fusion layer 202, so as to splice the vector expression of the above-described voice feature with the bottleneck feature corresponding to the reference voice, and obtain the fusion feature output by the feature fusion layer 202. The present disclosure is not limited to an implementation of splicing.

The fusion feature is used as the input of the second neural network 203, and the second neural network 203 obtains a matrix of a target dimension by spatially mapping the fusion feature, wherein the matrix output by the second neural network 203 is N*2 dimension, where N is a number of audio frames of the voice to be processed.

Each 1*2 sub-matrix in the matrix corresponds to one audio frame, based on a sub-matrix corresponding to each audio frame. The matrix output by the above-described second neural network 203 is input to the classification layer 204, so that the classification layer uses a preset classification function to perform calculation according to a matrix, and outputs a voice detection result of each audio frame.

As an example, the classification layer 204 uses the softmax function to calculate a submatrix corresponding to each audio frame to obtain the probabilities that the audio frame pertains to a first category and a second category respectively, and determine whether the audio frame matches the reference voice on the basis of a maximum value of the probabilities that the audio frame pertains to a first category and a second category respectively. Wherein, the audio frame comprised in the first category matches the reference voice, and the audio frame comprised in the second category does not match the reference voice.

Wherein, the voice detection result corresponding to each audio frame output by the classification layer 204 may be expressed by vectors of 0 and 1; when the voice detection result is 0, it means that the voice feature corresponding to the audio frame does not match the bottleneck feature corresponding to the reference voice, that is, the audio frame does not match the reference voice; when the voice detection result is 1, it means that the voice feature corresponding to the audio frame matches the bottleneck feature corresponding to the reference voice, that is, the audio frame matches the reference voice.

Then, the target audio segment matching the reference voice may be determined from the voice to be processed on the basis of a voice detection result of each audio frame. For example, all the audio frames with a voice detection result of 1 in the voice to be processed may be determined as an audio frame comprised in the target audio segment, so that a target audio segment may be separated.

It is also to be noted that, since the voice to be processed may comprise voice segments of a plurality of voice roles, and each voice role might also correspond to a plurality of voice segments which are discontinuous, the target audio segment may comprise one or more voice segments.

On the basis of the embodiment shown in FIG. 2, it may be known that, as compared with the voice separation by a method combining “VAD system+voice recognition and separation system”, the voice separation model provided by this disclosure may realize voice separation in an end-to-end manner, and the training process of the voice separation model provided by this disclosure is more simple. Moreover, the voice separation method provided by this disclosure takes the voice feature of the voice to be processed and the bottleneck feature of the reference voice as the joint input of the voice separation model for realizing voice separation, so that the accuracy of voice separation can be improved.

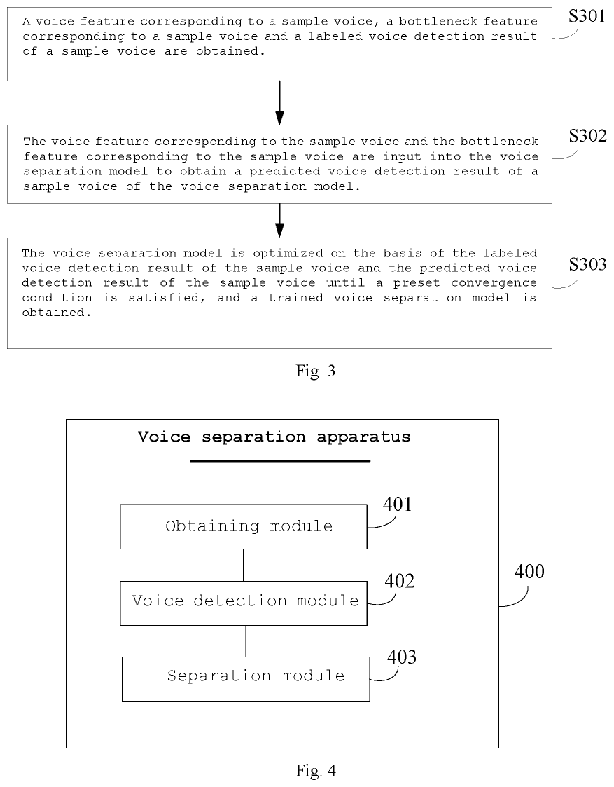

In conjunction with the aforementioned embodiments shown in FIG. 1 and FIG. 2, it may be known that the voice separation method provided by this disclosure may be realized by a voice separation model which is required to be trained in advance; how to train and obtain a voice separation model will be introduced below by way of the embodiment shown in FIG. 3.

FIG. 3 is a flow chart of a voice separation method provided by another embodiment of the present disclosure. Referring to FIG. 3, the method provided by this embodiment comprises:

In S301, a voice feature corresponding to a sample voice, a bottleneck feature corresponding to a sample voice and a labeled voice detection result of a sample voice are obtained.

In this solution, the sample voice comprises the above-described reference voice, that is, during the training process, it is necessary to ensure that the voice separation model has learned the feature of the reference voice, so as to ensure that the trained voice separation model may correctly recognize the audio frame matching the reference voice.

The present disclosure is not limited to parameters such as the number and content of the sample voice and the reference voice.

In one possible implementation, for the implementation of obtaining the voice feature of the sample voice and the bottleneck feature of the sample voice, reference may be made to a related description of S101 in the embodiment shown in FIG. 1 described previously.

In another possible implementation, if a sample voice and a voice feature of a sample voice, a bottleneck feature corresponding to a sample voice, a labeled voice detection result of a sample voice and the like are stored in some related databases in advance, reading may also be performed from the databases when the voice separation model is trained.

In S302, the voice feature corresponding to the sample voice and the bottleneck feature corresponding to the sample voice are input into the voice separation model to obtain a predicted voice detection result of a sample voice of the voice separation model.

In S303, the voice separation model is optimized on the basis of the labeled voice detection result of the sample voice and the predicted voice detection result of the sample voice until a preset convergence condition is satisfied, and a trained voice separation model is obtained.

A corresponding loss value may be calculated by using a preset loss function on the basis of the labeled voice detection result of the sample voice and the predicted voice detection result of the sample voice, and whether a preset convergence condition is satisfied may be determined according to the loss value; if a preset convergence condition is satisfied, the training is terminated, and if the preset convergence condition is not satisfied, the relevant parameters of the voice separation model may be optimized on the basis of the loss value. Next, a following round of training is performed on the sample voice until a preset convergence condition is satisfied, and a trained voice separation model is obtained.

The present disclosure is not limited to an implementation of a preset convergence condition. As an example, the preset convergence condition may be an evaluation index such as training iteration times and a loss threshold, and the like. It is also to be noted that, the present disclosure is not limited to a preset loss function.

During the training process, the voice separation model may be first trained by using the relevant data of a non-reference voice in the sample voice so that the voice separation model possesses certain voice separation capability. On this basis, the voice separation model may be trained on the basis of the relevant data of the reference voice so that the voice separation model has the ability to separate an audio frame matching the reference voice.

During the process of training the voice model, the voice feature of the reference voice and the bottleneck feature of other sample voices may be combined as the input of the voice separation model, so that the voice separation model performs learning.

This training may allow the voice separation model to learn not only correct samples, but also incorrect samples, thereby improving the performance of the voice separation model.

In the method provided by this embodiment, a voice feature corresponding to a sample voice, a bottleneck feature corresponding to a sample voice and a labeled voice detection result of a sample voice are obtained; the voice feature corresponding to the sample voice and the bottleneck feature corresponding to the sample voice are input into a voice separation model and a predicted voice detection result of a sample voice of the voice separation model is obtained; and the voice separation model is optimized on the basis of the labeled voice detection result of the sample voice and the predicted voice detection result of the sample voice until a preset convergence condition is satisfied, and a trained voice separation model is obtained.

As an example, the present disclosure also provides a voice separation device.

FIG. 4 is a schematic structural view of a voice separation device provided by one embodiment of the present disclosure. Referring to FIG. 4, the voice separation device 400 provided by this embodiment comprises:

An obtaining module 401, configured to obtain a voice feature corresponding to a voice to be processed and a bottleneck feature corresponding to a reference voice.

A voice detection module 402, configured to input the voice feature corresponding to the voice to be processed and the bottleneck feature corresponding to the reference voice into a voice separation model to obtain a voice detection result output by the voice separation model.

A separation module 403, configured to determine a target voice segment matching the reference voice in the voice to be processed on the basis of the voice detection result, wherein the voice feature of the target voice segment matches the bottleneck feature of the reference voice.

As one possible implementation, the voice detection result is used to indicate whether the voice feature of each audio frame comprised in the voice to be processed matches the bottleneck feature of the reference voice.

As one possible implementation, the voice detection module 402 is specifically configured to input the voice feature corresponding to the voice to be processed into a first neural network comprised in the voice separation model, and obtain a vector expression corresponding to the voice feature output by the first neural network; splicing the vector expression corresponding to the voice feature and the bottleneck feature corresponding to the reference voice to obtain a fusion feature; and inputting the fusion feature into a second neural network comprised in the voice separation model, obtaining a matrix output by the second neural network, and obtaining the voice detection result on the basis of the matrix.

As one possible implementation, the voice detection module 402 is specifically configured to obtain the probability values that the each audio frame pertains to a first category and a second category respectively according to an element corresponding to the each audio frame comprised in the matrix; wherein the voice feature corresponding to the audio frame comprised in the first category matches the bottleneck feature corresponding to the reference voice, and the voice feature corresponding to the audio frame comprised in the second category does not match the bottleneck feature corresponding to the reference voice; and determine a voice detection result corresponding to the each audio frame based on a maximum value of the probability values that the each audio frame pertains to a first category and a second category respectively.

Wherein, the voice detection result corresponding to the audio frame is used to indicate whether the voice feature corresponding to the audio frame matches.

As one possible implementation, the voice separation model is obtained by training on the basis of the voice feature corresponding to the sample voice, the bottleneck feature corresponding to the sample voice and the labeled voice detection result of the sample voice, and the sample voice comprises the reference voice.

As one possible implementation, the voice feature comprises one or more of a FBank feature, a Mel frequency spectrum feature, a bottleneck feature or a pitch feature.

The voice separation device provided by this embodiment may be used to realize the technical solution according to any of the method embodiments above with similar implementation principles and technical effects so that reference may be made to detailed description of the method embodiments described previously, which will not be described in detail here for the sake of conciseness.

As an example, the present disclosure further provides an electronic device.

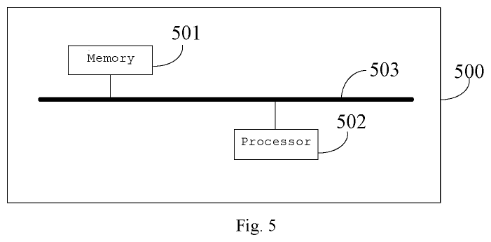

FIG. 5 is a schematic structural view of an electronic device provided by one embodiment of the present disclosure. Referring to FIG. 5, the electronic device 500 provided by this embodiment comprises: a memory 501 and a processor 502.

Wherein, the memory 501 may be an independent physical unit which may be connected with the processor 502 via a bus 503. The memory 501 and the processor 502 may also be integrated together and implemented by hardware.

The memory 501 is configured to store program instructions which are invoked by the processor 502 to perform the technical solution according to any of the above method embodiments.

Alternatively, when a part or an entirety of the method in the above-described embodiments is implemented by software, the above-described electronic device 500 may also only comprise the processor 502. The memory 501 for storing programs is located outside the electronic device 500, and the processor 502 is connected with the memory through a circuit/wire for reading and executing the programs stored in the memory.

The processor 502 may be a central processing unit (CPU), a network processor (NP) or a combination of CPU and NP.

The processor 502 may also further comprise a hardware chip. The above-described hardware chip may be an application-specific integrated circuit (ASIC), a programmable logic device (PLD) or a combination thereof. The above-described PLD may be a complex programmable logic device (CPLD), a field-programmable gate array (FPGA), a generic array logic (GAL) or any combination thereof.

The memory 501 may comprise a volatile memory such as a random-access memory (RAM); the memory may also comprise a non-volatile memory, such as a flash memory, a hard disk drive (HDD) or a solid-state drive (SSD); the memory may also comprise a combination of the above-described kinds of memories.

The present disclosure further provide a readable storage medium comprising: computer program instructions; when the computer program instructions are executed by at least one processor of the electronic device, the voice separation method shown in any of the above-described embodiments is implemented.

The present disclosure further provide a computer program product that, when executed by a computer, causes the computer to implement the voice separation method shown in any of the above-described embodiments.

It is to be noted that, the relational terms such as “first” and “second” herein are only used to distinguish one entity or operation from another entity or operation, but do not necessarily require or imply any such actual relationship or sequence present between these entities or operations. Moreover, the terms “comprising”, “including” or any other variation thereof are intended to cover non-exclusive inclusions, so that a process, method, article or device comprising a series of elements comprises not only those elements, but also other elements not explicitly listed or elements inherent to such process, method, article or device. In the case where there are no more restrictions, an element defined by the phrase “comprising one . . . ” does not exclude an additional identical element also present in the process, method, article or device comprising the element.

The above content only pertains to a detailed description of the present disclosure, so that those skilled in the art may understand or realize the present disclosure. Multiple modifications to these embodiments will be obvious for those skilled in the art, and the general principles defined herein may be realized in other embodiments without departing from the spirit or scope of this disclosure. Therefore, the present disclosure will not be limited to these embodiments described herein, but intended to conform to the broadest scope consistent with the principles and novel features disclosed herein.

1. A voice separation method, comprising:
obtaining a voice feature corresponding to a voice to be processed and a bottleneck feature corresponding to a reference voice;
inputting, into a voice separation model, the voice feature corresponding to the voice to be processed and the bottleneck feature corresponding to the reference voice and obtaining a voice detection result output by the voice separation model; and
determining, on a basis of the voice detection result, a target voice segment matching the reference voice in the voice to be processed, wherein the voice feature corresponding to the target voice segment matches the bottleneck feature corresponding to the reference voice.

2. The method according to claim 1, wherein the inputting, into a voice separation model, the voice feature corresponding to the voice to be processed and the bottleneck feature corresponding to the reference voice and obtaining a voice detection result output by the voice separation model comprises:
inputting the voice feature corresponding to the voice to be processed into a first neural network comprised in the voice separation model, and obtaining a vector expression corresponding to the voice feature output by the first neural network;
splicing the vector expression corresponding to the voice feature and the bottleneck feature corresponding to the reference voice to obtain a fusion feature; and
inputting the fusion feature into a second neural network comprised in the voice separation model, obtaining a matrix output by the second neural network, and obtaining a voice detection result on a basis of the matrix.

3. The method according to claim 2, wherein the obtaining a voice detection result on a basis of the matrix comprises:
obtaining probability values that each audio frame pertains to a first category and a second category respectively according to an element corresponding to the each audio frame comprised in the matrix; the voice feature corresponding to the audio frame comprised in the first category matches the bottleneck feature corresponding to the reference voice, and the voice feature corresponding to the audio frame comprised in the second category does not match the bottleneck feature corresponding to the reference voice; and
determining a voice detection result corresponding to the each audio frame on a basis of a maximum value of the probability values that the each audio frame pertains to a first category and a second category respectively.

4. The method according to claim 1, wherein the voice separation model is obtained by training on a basis of the voice feature corresponding to the sample voice, the bottleneck feature corresponding to the sample voice and a labeled voice detection result of the sample voice, and the sample voice comprises the reference voice.

5. The method according to claim 1, wherein the voice feature comprises one or more of a FBank feature, a Mel frequency spectrum feature or a pitch feature.

6-7. (canceled)

8. An electronic device comprising: a memory and a processor;
the memory is configured to store computer program instructions; and
the processor is configured to execute the computer program instructions, so that the electronic device implements voice separation method, comprising:
obtaining a voice feature corresponding to a voice to be processed and a bottleneck feature corresponding to a reference voice;
inputting, into a voice separation model, the voice feature corresponding to the voice to be processed and the bottleneck feature corresponding to the reference voice and obtaining a voice detection result output by the voice separation model; and
determining, on a basis of the voice detection result, a target voice segment matching the reference voice in the voice to be processed, wherein the voice feature corresponding to the target voice segment matches the bottleneck feature corresponding to the reference voice.

9. A non-transitory readable storage medium comprising: computer program instructions;
the computer program instructions, when executed by at least one processor of an electronic device, cause the electronic device to implement a voice separation method, comprising:
obtaining a voice feature corresponding to a voice to be processed and a bottleneck feature corresponding to a reference voice;
inputting, into a voice separation model, the voice feature corresponding to the voice to be processed and the bottleneck feature corresponding to the reference voice and obtaining a voice detection result output by the voice separation model; and
determining, on a basis of the voice detection result, a target voice segment matching the reference voice in the voice to be processed, wherein the voice feature corresponding to the target voice segment matches the bottleneck feature corresponding to the reference voice.

10. (canceled)

11. The electronic device according to claim 8, wherein the inputting, into a voice separation model, the voice feature corresponding to the voice to be processed and the bottleneck feature corresponding to the reference voice and obtaining a voice detection result output by the voice separation model comprises:
inputting the voice feature corresponding to the voice to be processed into a first neural network comprised in the voice separation model, and obtaining a vector expression corresponding to the voice feature output by the first neural network;
splicing the vector expression corresponding to the voice feature and the bottleneck feature corresponding to the reference voice to obtain a fusion feature; and
inputting the fusion feature into a second neural network comprised in the voice separation model, obtaining a matrix output by the second neural network, and obtaining a voice detection result on a basis of the matrix.

12. The electronic device according to claim 11, wherein the obtaining a voice detection result on a basis of the matrix comprises:
obtaining probability values that each audio frame pertains to a first category and a second category respectively according to an element corresponding to the each audio frame comprised in the matrix; the voice feature corresponding to the audio frame comprised in the first category matches the bottleneck feature corresponding to the reference voice, and the voice feature corresponding to the audio frame comprised in the second category does not match the bottleneck feature corresponding to the reference voice; and
determining a voice detection result corresponding to the each audio frame on a basis of a maximum value of the probability values that the each audio frame pertains to a first category and a second category respectively.

13. The electronic device according to claim 8, wherein the voice separation model is obtained by training on a basis of the voice feature corresponding to the sample voice, the bottleneck feature corresponding to the sample voice and a labeled voice detection result of the sample voice, and the sample voice comprises the reference voice.

14. The electronic device according to claim 8, wherein the voice feature comprises one or more of a FBank feature, a Mel frequency spectrum feature or a pitch feature.

15. The non-transitory readable storage medium according to claim 9, wherein the inputting, into a voice separation model, the voice feature corresponding to the voice to be processed and the bottleneck feature corresponding to the reference voice and obtaining a voice detection result output by the voice separation model comprises:
inputting the voice feature corresponding to the voice to be processed into a first neural network comprised in the voice separation model, and obtaining a vector expression corresponding to the voice feature output by the first neural network;
splicing the vector expression corresponding to the voice feature and the bottleneck feature corresponding to the reference voice to obtain a fusion feature; and
inputting the fusion feature into a second neural network comprised in the voice separation model, obtaining a matrix output by the second neural network, and obtaining a voice detection result on a basis of the matrix.

16. The non-transitory readable storage medium according to claim 15, wherein the obtaining a voice detection result on a basis of the matrix comprises:
obtaining probability values that each audio frame pertains to a first category and a second category respectively according to an element corresponding to the each audio frame comprised in the matrix; the voice feature corresponding to the audio frame comprised in the first category matches the bottleneck feature corresponding to the reference voice, and the voice feature corresponding to the audio frame comprised in the second category does not match the bottleneck feature corresponding to the reference voice; and
determining a voice detection result corresponding to the each audio frame on a basis of a maximum value of the probability values that the each audio frame pertains to a first category and a second category respectively.

17. The non-transitory readable storage medium according to claim 9, wherein the voice separation model is obtained by training on a basis of the voice feature corresponding to the sample voice, the bottleneck feature corresponding to the sample voice and a labeled voice detection result of the sample voice, and the sample voice comprises the reference voice.

18. The non-transitory readable storage medium according to claim 9, wherein the voice feature comprises one or more of a FBank feature, a Mel frequency spectrum feature or a pitch feature.
